(19) United States
(12) Patent Application Publication
(10) Pub. No.: US 2022/0164800 A1
(43) Pub. Date: May 26, 2022

(54) CARD SHAPED MOBILE PAYMENT DEVICE AND OPERATION METHOD THEREOF

(71) Applicant: BEAUTIFUL CARD CORPORATION, Taoyuan City (TW)

(72) Inventors: MENG-JEN CHENG, Taoyuan City (TW); CHIH-KAI YANG, Taoyuan City (TW)

(21) Appl. No.: 17/584,418

(22) Filed: Jan. 26, 2022

Related U.S. Application Data
(63) Continuation-in-part of application No. 17/100,971, filed on Nov. 23, 2020.

(51) Int. Cl. G06Q 20/40; G06Q 20/34; G06Q 20/38

(52) U.S. Cl. CPC G06Q 20/40145; G06Q 20/3825; G06Q 20/352; G06Q 20/4012

(57) ABSTRACT

The present disclosure provides a card shaped mobile payment device, which includes a card shaped casing and an offline payment execution module configured for executing an offline payment operation and disposed in the card shaped casing. The offline payment execution module includes a display module, a security chip, an antenna unit and a central control unit. The display module is used for displaying card information; the security chip is used for generating a token information, which is time-sensitive, and executing a transaction procedure. The antenna unit is electrically connected to the security chip for providing the token information to a transaction device. The central control unit activates the security chip according to a received identity authentication result, and provides a card index information corresponding to the card information to the security chip, so as to access a stored card credential and generate the token information.

### CROSS-REFERENCE TO RELATED APPLICATION

This application is a continuation-in-part patent application of U.S. application Ser. No. 17/100,971 filed on Nov. 23, 2020, the entire contents of which are hereby incorporated by reference for which priority is claimed under 35 U.S.C. § 120.

### BACKGROUND OF THE INVENTION

### 1. Field of the Invention

The present disclosure relates to a mobile payment device and an operation method thereof, and in particular to a card shaped mobile payment device for offline payment and an operation method thereof.

### 2. Description of the Related Art

Generally, different merchants will use different marketing methods to encourage consumers to consume according to their business strategies. Common marketing methods include membership discounts, special credit card discounts, etc. In order to obtain various discount qualifications, consumers often hold multiple cards.

However, in order to use the discounts, consumers not only hold multiple cards, but also carry them frequently. Multiple cards not only take up space and weight for consumers, but are also difficult to manage, which obviously bothers consumers.

In addition, although the current mobile payment by a mobile phone or wearable mobile payment can solve the problem that the traditional card is not easy to carry, inconvenience still exists. As to the mobile payment by the mobile phone, since the mobile payment institution is a part of the mobile phone, when there is a problem with the mobile phone function, the payment function will also be affected, or even temporarily unavailable, such as battery exhaustion, screen damage, and inability to connect to the Internet. In addition, the mobile payment also has security problems, such as operating system virus and transaction data hacking. As to the mobile payment with wearable devices, there are problems such as the inability to improve the security identification level (such as only passwords can be used) and inconvenience in payment (such as the unnatural posture of the transaction device) due to the limitation of size design.

### BRIEF SUMMARY OF THE INVENTION

The present disclosure provides a card shaped mobile payment device and an operation method thereof which can digitize and store information of multiple cards in a single card shaped mobile payment device, solve the drawbacks and security concerns of modern mobile payment, conduct offline and independent transactions, and also have a security authentication mechanism that complies with the requirements of international credit card institutions, thereby enhancing the convenience and security of the card shaped mobile payment device.

In order to achieve the above objects, the present disclosure provides a card shaped mobile payment device, including a card shaped casing and an offline payment execution module configured for executing an offline payment operation and disposed in the card-shaped casing. The offline payment execution module includes a display module, a security chip, an antenna unit, and a central control unit. The display module is used for displaying a card information; the security chip is used for generating a token information, which is time-sensitive, and executing a transaction procedure; the antenna unit is electrically connected to the security chip for providing the token information to a transaction device; and the central control unit is electrically connected to the display module and the security chip, wherein the central control unit activates the security chip according to a received identity authentication result, and provides a card index information corresponding to the card information to the security chip, such that the security chip uses the card index information to access a card credential stored in the security chip and corresponding to the card index information, and generates the token information.

In order to achieve the above objects, the present disclosure provides an operation method of a card shaped mobile payment device, in which the card shaped mobile payment device includes a security chip, an antenna unit electrically connected to the security chip, a central control unit electrically connected to the security chip. The operation method includes: executing an identity authentication operation, wherein the central control unit determines whether the identity authentication operation is successful according to a dual authentication result, and the dual authentication result includes a fingerprint authentication result and a PIN code authentication result of the security chip; and executing an offline payment operation, which includes confirming a card information, wherein the central control unit transmits a card index information of a selected card information to the security chip; activating a payment process, wherein the security chip generates a token information, which is time-sensitive, based on the card credential information corresponding to the card index information; and executing a transaction operation, such that the antenna unit establishes a communication connection with a transaction device, so as to provide the token information to the transaction device to execute a transaction.

Based on the above steps and structure, users do not need to carry multiple physical cards, but only need to carry a single card shaped mobile payment device to select multiple payment information. In addition, the card shaped mobile payment device only pays with token information which is time-sensitive so as to effectively avoid the risk of leaking confidential information. Further, the card shaped mobile payment device performs payment operations in an offline environment, which not only improves the security of payment, but also reduces the power required for the operation of the card shaped mobile payment device. Therefore, the present disclosure achieves improving the convenience and security of the usage of the card shaped mobile payment device.

### BRIEF DESCRIPTION OF THE DRAWINGS

FIG. 1 is a schematic diagram illustrating a card shaped mobile payment device according to an embodiment of the present disclosure.

FIG. 2 is another schematic diagram illustrating a card shaped mobile payment device according to an embodiment of the present disclosure.

FIG. 3 is a top view showing a card shaped mobile payment device according to an embodiment of the present disclosure.

FIG. 4 is a schematic view illustrating a card shaped mobile payment device according to an embodiment of the present disclosure.

FIG. 5 is a top view showing an arrangement of a display module and an antenna unit according to an embodiment of the present disclosure.

FIG. 6 is another top view showing a card shaped mobile payment device according to an embodiment of the present disclosure.

FIG. 7 is another top view showing a card shaped mobile payment device according to an embodiment of the present disclosure.

FIG. 8 is a flow diagram I illustrating the steps of a card shaped mobile payment device according to an embodiment of the present disclosure.

FIG. 9 is a flow diagram II illustrating the steps of a card shaped mobile payment device according to an embodiment of the present disclosure.

FIG. 10 is a flow diagram III illustrating the steps of a card shaped mobile payment device according to an embodiment of the present disclosure.

FIG. 11 is a flow diagram IV illustrating the steps of a card shaped mobile payment device according to an embodiment of the present disclosure.

FIG. 12 is a flow diagram V illustrating the steps of a card shaped mobile payment device according to an embodiment of the present disclosure.

### DETAILED DESCRIPTION OF THE INVENTION

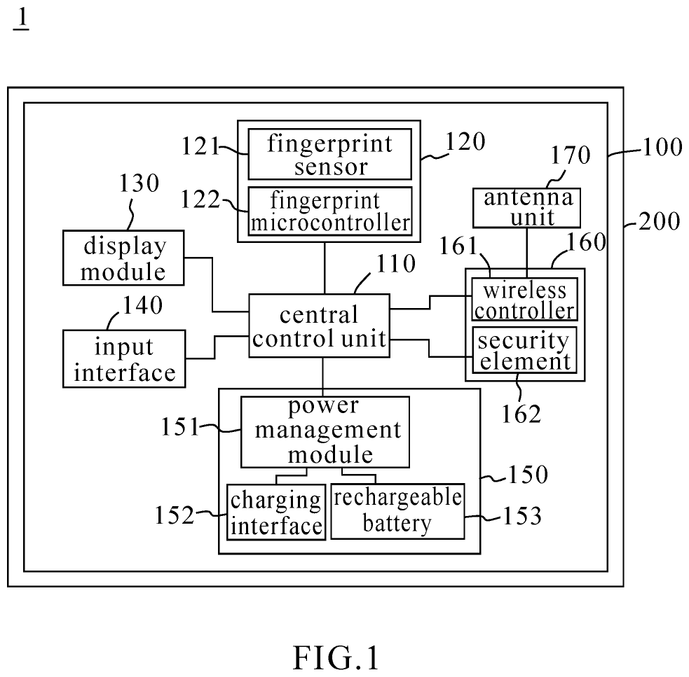

FIGS. 1-4 show a card shaped mobile payment device 1 according to an embodiment of the present disclosure. FIG. 1 is a schematic diagram illustrating the card shaped mobile payment device 1 according to an embodiment of the present disclosure. The card shaped mobile payment device 1 includes a card shaped casing 200 and an offline payment execution module 100 disposed in the card shaped casing 200. The offline payment execution module 100 includes a central control unit 100, a fingerprint sensing module 120, a display module 130, an input interface 140, a power module 150, a security chip 160 and an antenna unit 170, wherein the central control unit 110 is electrically connected to the fingerprint sensing module 120, the display module 130, the input interface 140, the power module 150 and the security chip 160.

The fingerprint sensing module 120 is used for receiving a fingerprint information of the user of the card shaped mobile payment device 1 for identity authentication. The fingerprint sensing module 120 includes a fingerprint sensor 121 and a fingerprint microcontroller 122, the fingerprint sensor 121 is electrically connected to the fingerprint microcontroller 122, and the fingerprint microcontroller 122 is electrically connected to the central control unit 110. The fingerprint sensor 121 is used for receiving and sensing the fingerprint information of the user of the card shaped mobile payment device 1, generating corresponding fingerprint sensing information, and transmitting the sensed fingerprint sensing information to the fingerprint microcontroller 122. The fingerprint microcontroller 122 stores at least one fingerprint information, receives the fingerprint sensing information, determines whether the fingerprint sensing information is consistent with the at least one fingerprint information to generate a determination result, generates a fingerprint authentication result according to the determination result, and provides the fingerprint authentication result to the central control unit, wherein the fingerprint authentication result indicates whether the fingerprint sensing information is consistent with the stored at least one fingerprint information.

The display module 130 is used to show a display image, and the display image may include at least one card information, password input instruction information or other instruction images required for the operation of the card shaped mobile payment device 1. In an embodiment, the card information includes the last four digits of a sixteen-digit credit card number (PAN). In another embodiment, the card information may include non-confidential information such as a card abbreviation, a card type, and an expiration date. In other words, the card shaped mobile payment device 1 of the present disclosure does not directly display the confidential information related to the credit card, thereby further enhancing the security of the confidential information.

In an embodiment, the display module 130 is a bistable display, such as an electrophoretic ink display or an electrowetting display, and the present disclosure is not limited thereto.

The input interface 140 is used for generating corresponding input signals according to the operation of the user. In this embodiment, the input signal is used to control the display screen of the display module 130, such as switching the displayed card information or inputting a password.

In an embodiment, the input interface 140 is, for example, a touch switch or a touch panel embedded in the display module 130, and the present disclosure is not limited thereto.

The power module 150 includes a power management module 151, a charging interface 152 and a rechargeable battery 153, and the power management module 151 is electrically connected to the charging interface 152 and the rechargeable battery 153, wherein the power management module 151 manages and provides the power required for the operation of the card shaped mobile payment device 1, and provides the central control unit 110 with the charging and discharging status of the rechargeable battery 153. In an embodiment, the rechargeable battery 153 is a thin rechargeable battery.

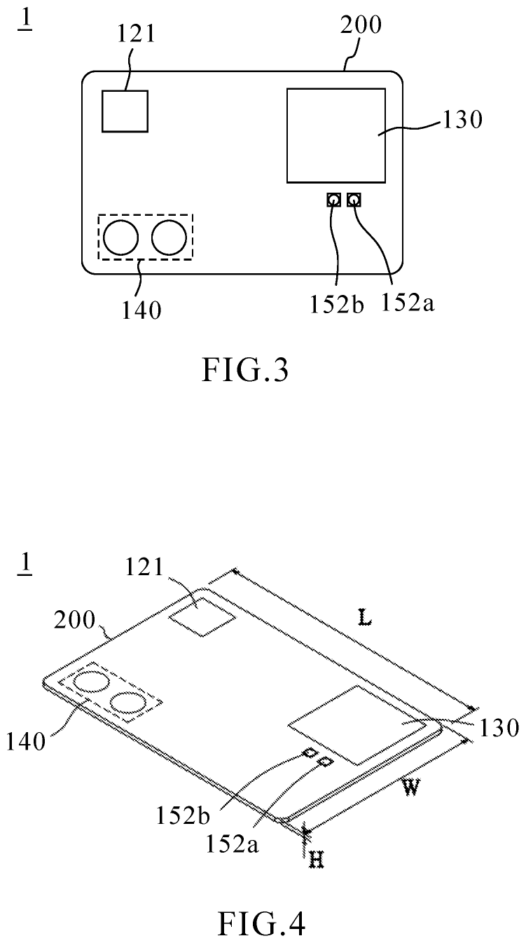

The charging interface 152 includes a ground point 152b and a positive voltage point 152a (as shown in FIG. 3), wherein the ground point 152b and the positive voltage point 152a are in contact with and electrically connected to a charging device, so as to charge the rechargeable battery 153 by the charging device.

The security chip 160 is used for receiving the card index information transmitted by the central control unit, generating corresponding token information, and providing the token information to the antenna unit 170.

The security chip 160 includes a wireless controller 161 and a security element 162, and the security element 162 stores at least one card index information, at least card credential information and an authentication PIN code which are corresponding to the at least one card index information. The secure element 162 is used to perform a PIN code authentication operation, receive the pre-stored PIN code transmitted by the central control unit 110, compare the pre-stored PIN code with the authentication PIN code, generate a PIN code authentication result according to the comparison result, and transmits the PIN code authentication result to the central control unit 110. After the PIN code authentication operation is successful, the secure element 162 receives the card index information transmitted by the central control unit 110, searches for and confirms the card credential information corresponding to the received card index information in the stored at least one card credential information according to the received card index information, and performs the operation of time-sensitive tokenization on the confirmed card credential information to generate corresponding token information.

The card credential information is a combination of data certified by an international credit card organization and associated with confidential information such as a credit card number, a security code, an expiration date, a name, etc., and is the input data before tokenization. In other words, the card shaped mobile payment device 1 of the present disclosure does not directly display and does not store the above-mentioned confidential information in plain text, thereby further enhancing the security of the confidential information.

The tokenization is performed to convert the card credential information into an unrecognizable token, which is time-sensitive. Thus, the security element 162 performs the tokenization on the same card credential information at different time points to generate different token information. By the tokenization of the card credential information, instead of using the credit card number and other confidential information for transactions, it can effectively reduce the risk of confidential information being stolen and improve the security of payment.

The wireless controller 161 is electrically connected to the security element 162, the wireless controller 161 receives the start payment procedure command transmitted by the central control unit 110, then interacts with the security element 162 to enter the payment procedure, transmits the token information to the antenna unit 162, which is coupled with the transaction device, thereby completing the transaction.

Therefore, the card shaped mobile payment device of the present disclosure completes the transaction by establishing a communication connection with the transaction device through Near-Field Communication. In other words, the card shaped mobile payment device of the present disclosure not only does not need to be physically connected with other electronic devices, but also does not need to establish a communication connection with the Internet when performing payment transactions, and the card shaped mobile payment device of the present disclosure completes the payment transaction in an offline manner. The card shaped mobile payment device of present disclosure only uses the information inside the card shaped mobile payment device to independently complete the transaction during the payment transaction.

In an embodiment, the wireless controller 161 is a near field communication (NFC) controller.

The antenna unit 170 is electrically connected to the security chip 160 for receiving and transmitting the token information to the coupled transaction device (not shown).

In an embodiment, the antenna unit 170 is a near field communication (NFC) antenna.

The central control unit 110 is used for monitoring the fingerprint sensing module 120, the display module 130, the input interface 140, the power module 150 and the security chip 160, such that the card shaped mobile payment device 1 can execute corresponding operations. The central control unit 110 is used for storing at least one card information, a card index information corresponding to the card information, and a pre-stored PIN code. The card information includes non-confidential information such as the last four digits of a sixteen-digit credit card number (PAN), a card abbreviation, a card type, and an expiration date which are used for the user of the card shaped mobile payment device 1 to recognize the physical credit card which is represented by the card information.

Further, the central control unit 110 is used for receiving a dual authentication result to determine whether an identity authentication operation is successful, so as to determine whether to wake up the card shaped mobile payment device 1 from the disabled state to the enabled state.

The identity authentication operation includes a fingerprint authentication operation and a PIN code authentication operation.

The fingerprint authentication operation is used to make the fingerprint sensing module 120 perform a fingerprint sensing operation. When the fingerprint authentication result indicates that the fingerprint sensing information is consistent with the stored at least one fingerprint information, the central control unit 110 executes the PIN code authentication operation. In the PIN code authentication operation, the central control unit 110 transmits the pre-stored PIN code to the security element 162, receives the PIN code authentication result transmitted by the security element 162, and determines according to the PIN code authentication result whether the identity authentication operation is successful. When the central control unit 110 determines according to the PIN code authentication result that the identity authentication operation is successful, the central control unit 110 wakes up the card shaped mobile payment device 1 from a disabled state to an enabled state.

In an embodiment, when the central control unit 110 determines that the identity authentication operation fails (i.e., the fingerprint authentication result indicates that the fingerprint sensing information is not consistent with the stored at least one fingerprint information) and the number of failed fingerprint authentication operations exceeds a threshold value, the central control unit 110 makes the card shaped mobile payment device 1 execute a user PIN code authentication operation. The central control unit 110 receives the input PIN code corresponding to the operation command input from the input interface 140 by the user, and compares the input PIN code with the pre-stored PIN code stored in the central control unit 110. When the input PIN code is consistent with the pre-stored PIN code, the PIN code authentication operation is successful.

In an embodiment, when the central control unit 110 determines that the identity authentication operation fails and the number of failed fingerprint authentication operations exceeds a threshold value, the central control unit 110 makes the card shaped mobile payment device 1 execute a lock mode to disable the card shaped mobile payment device 1.

In an embodiment, when the card shaped mobile payment device 1 execute the lock mode, the central control unit 110 can be communicate with an electronic device, such that the electronic device executes an authentication operation, and after the authentication operation is completed, the lock mode is released. Further, the electronic device is installed with an application program corresponding to the card shaped mobile payment device 1, and the electronic device establishes a communication connection with the central control unit 110 through the application program. The authentication operation may be password authentication, fingerprint authentication, face authentication and other authentication methods performed on the user interface of the electronic device using the identity authentication device (camera, fingerprint sensing module, etc.) of the electronic device. After the authentication operation is completed at the electronic device, the lock mode of the card shaped mobile payment device 1 is released.

Further, after completing the identity authentication operation, the central control unit 110 determines the execution mode of the card shaped mobile payment device 1 according to the charging and discharging status of the rechargeable battery. When the central control unit 110 determines that the card shaped mobile payment device is in a non-charging state, it executes the offline payment operation in an offline payment mode. When the central control unit 110 determines that the card shaped mobile payment device 1 is in a charging state, i.e., the card shaped mobile payment device 1 is connected to and charged by a charging device, the card shaped mobile payment device 1 executes a connection control mode and communicates with an electronic device, such that the electronic device can control the operations of the card shaped mobile payment device 1, such as turning off the card shaped mobile payment device, resetting the card device, loading card information and payment information, inputting texts, inputting commands, etc.

In an embodiment, the central control unit 110 is a system on chip or a combination of a microcontroller (MCU) and a communication interface chip. The communication interface of the central control unit 110 may include Bluetooth, wireless network (Wi-Fi) and/or ultra-wideband (UWB) and the like. The card shaped mobile payment device 1 can establish a communication connection with an electronic device through wireless communication.

Further, the central control unit 110 can dynamically adjust the charging current mechanism according to the component states of the card shaped mobile payment device 1. For example, when the security chip 160 is actuated (for example, data are loaded into the security chip 160), the power consumption is greater than or slightly equal to the capacity of the rechargeable battery, and in order to avoid battery over-discharge or draw battery power with high current for a long time, the charging current provided by the charging device will be increased from low-current charging to high-current charging at this time. In this way, the high current for charging can compensate for the high discharging current generated by the security chip 160.

Further, when the central control unit 110 determines that the card shaped mobile payment device 1 executes the offline payment mode, the central control unit 110 enables the display screen of the display module 130 to enter the card information menu function for showing a card information list including multiple card information, and transmitting the card index information corresponding to the card information to be used for executing the payment transaction to the security chip. The card information to be used for executing the payment transaction is the card information selected by the user using the input interface 140 to input the operation command, or the card information that the user does not input an operation command through the input interface 140 and the display time of the display screen exceeds a preset value. For example, the user selects one card information from multiple card information through the input interface 140, and then performs no further operations, such that the current display screen continues to display and exceeds the preset value (for example, 5 seconds). Thus, the central control unit 110 sets the card information of the currently displayed screen as the card information to be used for executing the payment transaction, thereby effectively improving the convenience of operation of the card shaped mobile payment device 1.

Further, when the central control unit 110 determines that the card shaped mobile payment device 1 executes the connection control mode, the central control unit 110 communicates with an electronic device, and the application program of the electronic device controls the card shaped mobile payment device 1.

In an embodiment, the central control unit 110 enables the display module 130 to display two consecutively displayed display images in different directions. For example, when the display screen of the display module 130 is ready to switch from the fingerprint authentication image to the image of the PIN code authentication operation, the display module 130 can rotate the display image of the password input by 90° and then display it, so as to prompt the user to enter the next operation process or prompt that an abnormal state occurs, thereby improving the experience of the user using the card shaped mobile payment device 1.

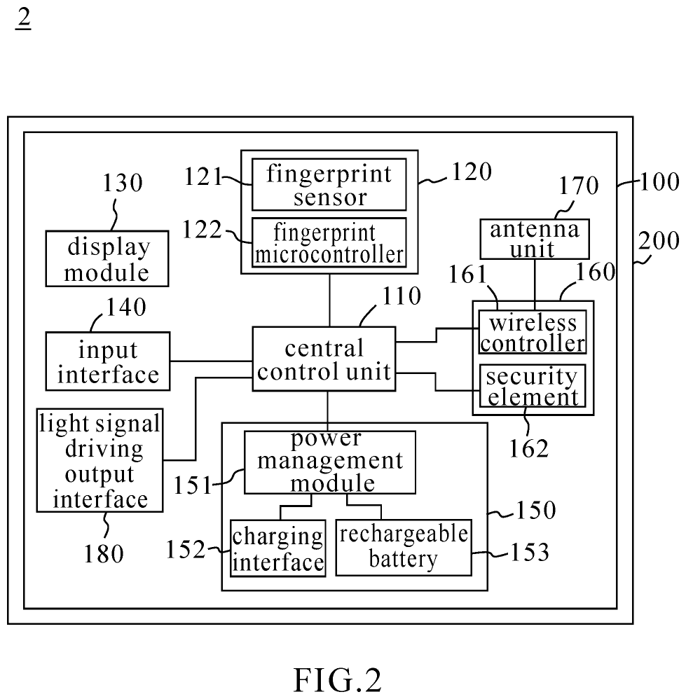

Referring to FIG. 2, FIG. 2 is a schematic diagram illustrating a card shaped mobile payment device according to another embodiment of the present disclosure. In this embodiment, the card shaped mobile payment device 2 further includes a light signal driving output interface 180. The light signal driving output interface 180 is an electrical contact point and electrically connected to the central control unit 110. When the card shaped mobile payment device 2 is connected to a charging device, the light signal driving output interface is used for outputting a state indicating signal associated with the card shaped mobile payment device 2 to the charging device, so as to drive the light signal on the charging device. The status of the light signal can be used to indicate whether the card shaped mobile payment device 2 is normally connected to the charging device, the charging status of the rechargeable battery, or other statuses.

In an embodiment, the charging device is a slot-type charging device.

Referring FIG. 3, FIG. 3 is a top view showing the card shaped mobile payment device 1 according to an embodiment of the present disclosure. The card shaped casing 200 exposes the fingerprint sensor 121, the display module 130, the input interface 140, the positive voltage point 152a and the ground point 152b.

Further, in this embodiment, the charging interface 152 is disposed on one side of the display module 140 and is away from one side of the fingerprint sensor 121, wherein the ground point 152b and the positive voltage point 152a are horizontally arranged in the same direction, the positive voltage point 512a is adjacent to an edge of the card shaped mobile payment device 1, and the ground point 152b is away from the edge of the card shaped mobile payment device 1. When the card shaped mobile payment device 1 is in contact with and connected to the charging device, the positive voltage point 152a is adjacent to the edge of the card shaped mobile payment device 1 and thus the power end of the charging device is in contact with the positive voltage point 152a. The charging device is not in contact with the ground point 152b and thus is not short-circuited, thereby effectively preventing the charging device and/or the card shaped mobile payment device 1 from being damaged due to a short circuit, and improving the safety of the card shaped mobile payment device 1 in use.

In an embodiment, the fingerprint sensor 121, the display module 130, the input interface 140, the positive voltage point 152a and the ground point 152b are at least 2 mm away from the edge of the card shaped casing 200, so as to ensure the stable structure of the card shaped casing 200. In an embodiment, the fingerprint sensor 121 and the input interface 140 must be disposed on the side away from the positive voltage point 152a and the ground point 152b, and keep a distance of more than 10 mm from the positive voltage point 152a and the ground point 152b, thereby ensuring that when the card shaped mobile payment device 1 is charged by a charging device, the fingerprint sensor 121 and the input interface 140 are not blocked by the charging device and can be used normally.

Referring to FIG. 4, FIG. 4 is a schematic view illustrating the card shaped mobile payment device 1 according to an embodiment of the present disclosure. A length L, a width W and a height H of the card shaped casing 200 of the card shaped mobile payment device 1 are defined. In this embodiment, the length L can be between 85.1 mm and 86.1 mm, and the length L is preferably 85.6 mm. In this embodiment, the width W can be between 53.48 mm and 54.48 mm, and the width W is preferably 53.98 mm. In this embodiment, the height H can be between 0.75 mm and 1.5 mm, and the height H is preferably 0.80 mm. The size of the card shaped mobile payment device 1 can meet the requirements of the international standard ISO/IEC7810-ID1.

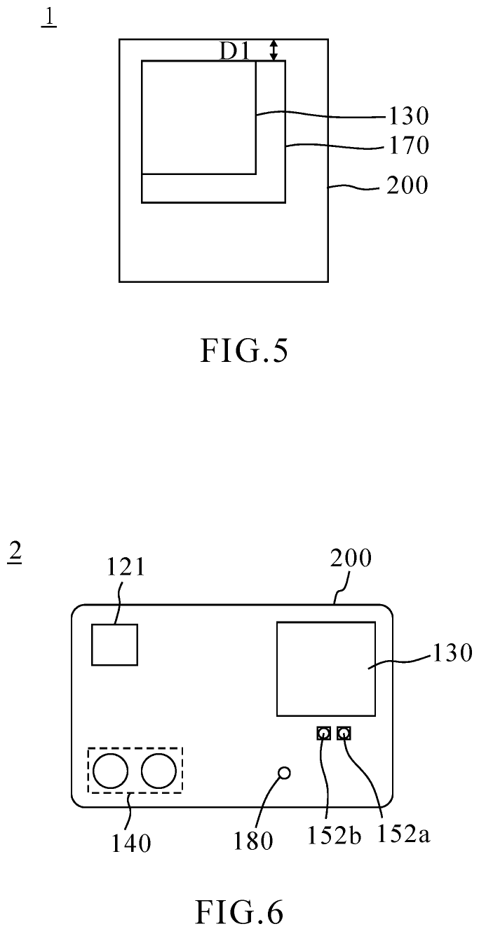

Referring to FIG. 5, FIG. 5 is a top view showing an arrangement of the display module 130 and the antenna unit 170 according to an embodiment of the present disclosure. The antenna unit 170 and the display module 130 are disposed in the card shaped casing, and the vertical projections of the antenna unit 170 and the display module 130 on the card shaped casing 200 approximately overlap each other. In an embodiment, the distance between the any two sides of the antenna unit 170 and the corresponding two sides of the display module 130 can be between 0 mm and 0.2 mm. For example, in the embodiment of FIG. 5, the two sides of the display module 130 at the upper left side overlap the two sides of the antenna unit 170, such that the distance between the side of the display module 130 and the side of the antenna unit 170 is 0 mm. Since the display module 130 is approximately overlapped in the card shaped casing 200, air bubbles and foreign objects from the edge of the card can be prevented from intruding into the card during the manufacturing process, thereby effectively improving the manufacturing yield of the card shaped mobile payment device 1.

In an embodiment, the distance between at least one of the antenna unit 170 and the display module 130 and an edge of the card shaped casing 200 is between 0.2 mm and 0.6 mm.

Referring to FIG. 6, FIG. 6 is top view showing the card shaped mobile payment device 2 according to an embodiment of the present disclosure. The card shaped casing 200 exposes the light signal driving output interface 180.

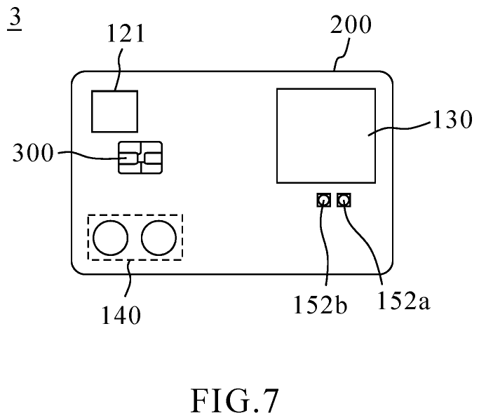

Referring to FIG. 7, FIG. 7 is a top view showing the card shaped mobile payment device 3 according to an embodiment of the present disclosure. The card shaped mobile payment device 3 further includes a smart card chip module 300, which is disposed in the card shaped casing 200 and is electrically independent from the offline payment execution module 100. In an embodiment, the smart card chip module 300 is a contact smart card chip or a contactless smart card chip. When the card shaped mobile payment device 3 cannot perform offline payment operations, traditional financial transaction operations can still be performed by the smart card chip module 300. In an embodiment, the smart card chip module can be implemented by a credit card chip or a debit card chip. In the embodiment in which the smart card chip module is a debit card chip, the account of the debit card chip is the debit account of the credit card corresponding to the card information.

In this embodiment, the height H of the card shaped mobile payment device can be between 0.76 mm and 0.84 mm.

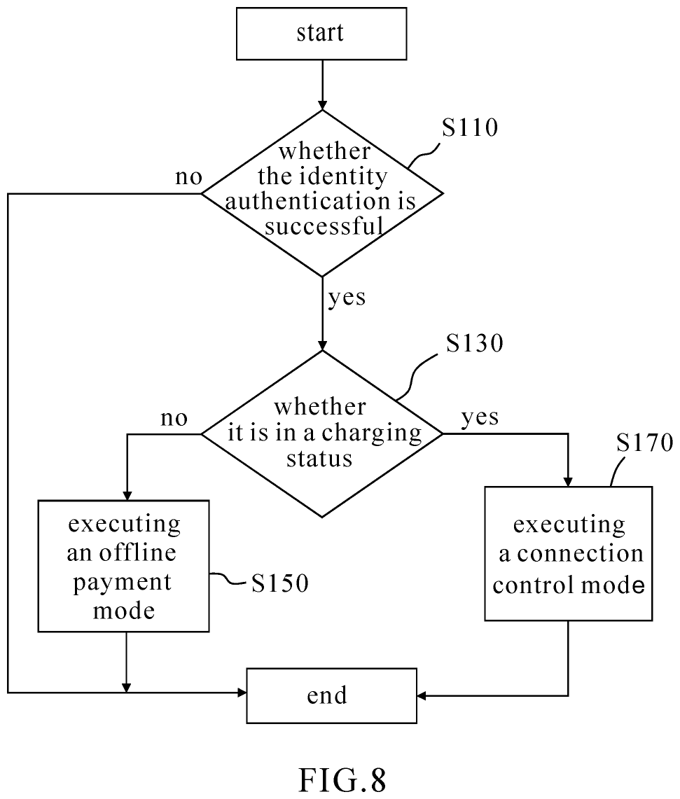

From the above-mentioned embodiments and application methods of the present disclosure, an operation method of a card shaped mobile payment device can be summarized, and the card shaped mobile payment device can be realized by the above-mentioned embodiments of FIG. 1 to FIG. 7. The operation method illustrated in FIG. 8 includes the following steps.

Step S110: executing an identity authentication operation. The central control unit 110 determines whether the identity authentication operation is successful. If it is determined that the identity authentication operation is successful, Step S130 is executed. If it is determined that the identity authentication operation is not successful, the procedure is ended.

Step S130: determining an execution mode. The central control unit 110 determines a charging and discharging status of a rechargeable battery. When the rechargeable battery is in a non-charging status, Step S150 is executed to execute an offline payment mode. Otherwise, Step S170 is executed to execute a connection control mode. After Step S150 or S170 is executed, this step ends.

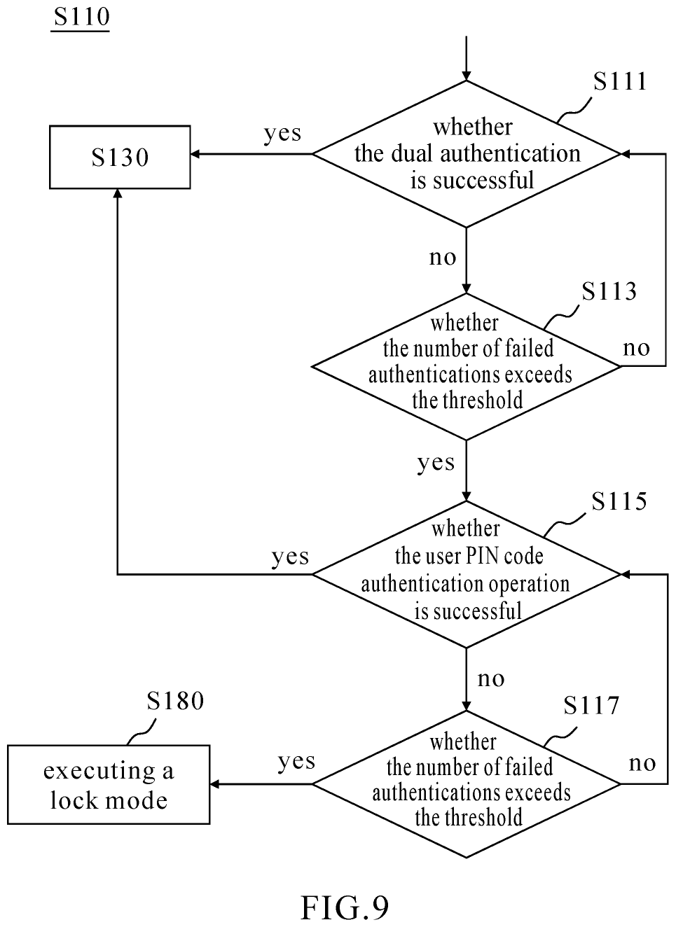

Further, Step S110 further includes the following steps, as shown in FIG. 9.

Step S111: executing a dual authentication operation. The central control unit 110 determines whether the identity authentication operation is successful according to a dual authentication operation result. If it is determined that the identity authentication operation is successful, Step S130 is executed. If it is determined that the identity authentication operation is not successful, Step S113 is executed.

Step S113: determining whether the number of authentication failures exceeds a threshold. The central control unit 110 determines whether the number of fingerprint authentication failures exceeds the threshold. If it is determined that the number of fingerprint authentication failures does not exceed the threshold, the procedure returns to Step S111 to continue the dual authentication operation. If it is determined that the number of fingerprint authentication failures exceeds the threshold, Step S115 is executed.

Step S115: executing a user PIN code authentication operation. The central control unit 110 receives the input PIN code input by the holder of the card shaped mobile payment device, and compares the input PIN code and the pre-stored PIN code stored in the central control unit 110. If the input PIN code is consistent with the pre-stored PIN code, the user PIN code authentication operation is successful. If the input PIN code is not consistent with the pre-stored PIN code, the user PIN code authentication operation is not successful. If the user PIN code authentication operation is successful, Step S130 is executed. If the user PIN code authentication operation is not successful, Step S117 is executed.

Step S117: determining whether the number of authentication failures exceeds a threshold. The central control unit 110 determines whether the number of the failed user PIN code authentication operations exceeds a threshold. If the number of the failed user PIN code authentication operations does not exceed the threshold, the procedure returns to Step S115 to continue the user PIN code authentication operation. If the number of the failed user PIN code authentication operations exceeds the threshold, Step S180 is executed.

Step S180: executing a lock mode. The central control unit 110 enables the card shaped mobile payment device to execute a lock mode, and the card shaped mobile payment device is disabled.

In an embodiment, the central control unit 110 communicates with an electronic device, the electronic device performs an authentication operation, and after the completion of the authentication operation, the lock mode is released, such that an unlock operation is completed.

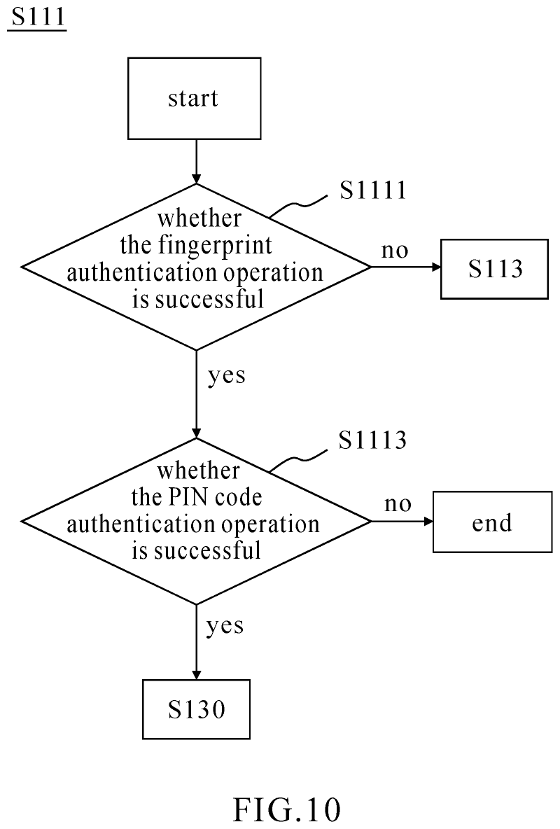

Further, Step S111 includes the following steps, as shown in FIG. 10.

Step S1111: determining whether a fingerprint authentication operation is successful. The central control unit 110 receives a fingerprint authentication result generated by a fingerprint sensing module, and determines according to the fingerprint authentication result whether the fingerprint authentication operation is successful. If the fingerprint authentication operation is successful, Step S1113 is executed. If the fingerprint authentication operation is not successful, Step S113 is executed.

Step S1113: determining whether a PIN code authentication operation is successful. The central control unit 110 transmits a pre-stored PIN code to the security chip 160, such that the security chip 160 compares the pre-stored PIN code with the authentication PIN code stored in the security chip 160 to generate a corresponding PIN code authentication result, and the central control unit 110 receives the PIN code authentication result and determines accordingly whether the PIN code authentication operation is successful. If it is determined that the PIN code authentication operation is successful, i.e., the dual authentication operation is successful, Step S130 is executed. If it is determined that the PIN code authentication operation is not successful, the step is ended and the card shaped mobile payment device is disabled.

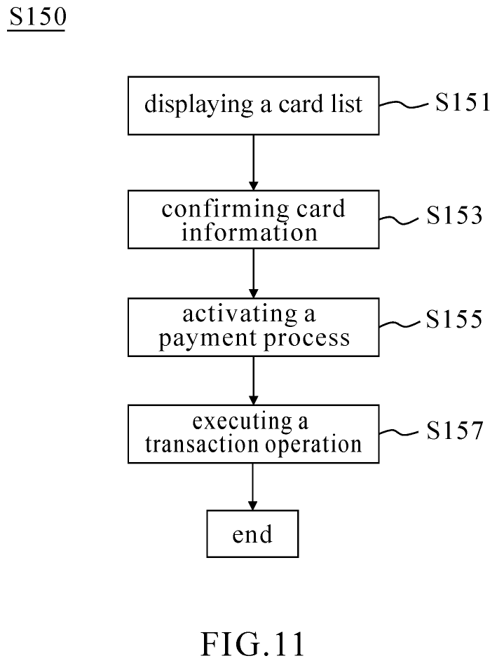

Further, Step S150 includes the following steps, as shown in FIG. 11.

Step S151: displaying a card list. The central control unit 110 enables the display module 130 to display the card list including multiple card information, and Step S153 is executed.

Step S153: confirming card information. The central control unit 110 determines that one card information from the multiple card information is the card information used to execute the payment transaction, and Step S155 is executed.

Step S155: starting a payment process. The central control unit 110 transmits the card index information of the card information used to execute the payment transaction to the security chip 160, such that the security chip 160 searches for the corresponding card credential information according to the card index information, and generates time-sensitive token information according to the card credential information. Then, Step S157 is executed.

Step S157: executing a transaction operation. The security chip 160 enables an antenna unit 170 to communicates with a transaction device, so as to provide the token information to the transaction device for transaction execution.

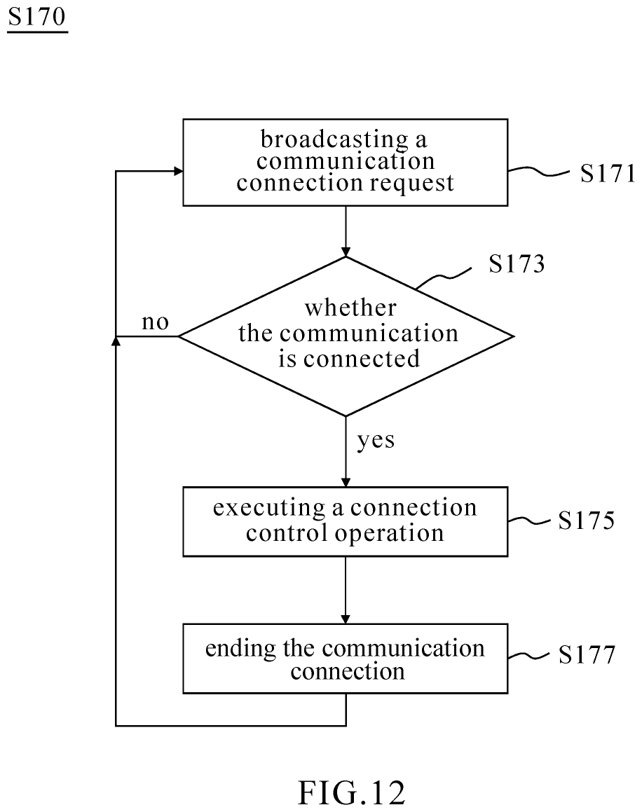

Further, Step S170 includes the following steps, as shown in FIG. 12.

Step S171: broadcasting communication connection requests. The central control unit 110 broadcasts a communication connection request signal to establish a communication connection with an electronic device. Then, Step S173 is executed.

Step S173: determining whether the communication is connected. The central control unit 110 determines whether a communication connection has been established with the electronic device according to whether a signal for establishing a communication connection is received from the electronic device. If yes, Step S175 is executed. If no, Step S171 is executed to continue broadcasting communication connection requests.

Step S175: executing a wired control operation. After the central control unit 110 has established a communication connection with the electronic device, the user can operate the application program of the electronic device, and use the user interface provided by the application program to remotely execute the operation and/or data exchange of the card shaped mobile payment device, such as turning off the card shaped mobile payment device, resetting the card device, loading card information and payment information, inputting texts, inputting commands, etc. Then, Step S177 is executed.

Step S177: after Step S175 is completed, the user can terminate the communication connection with the card shaped mobile payment device through the electronic device, after the central control unit 110 receives the signal of ending the communication connection from the electronic device, the central control unit 110 ends the communication connection with the electronic device, and the procedure returns to Step S171 and waits for the next communication connection.

According to the present disclosure, the digitized credential information of multiple physical cards is stored in a single card shaped mobile payment device, such that the user of the card shaped mobile payment device does not need to carry a plurality of cards, and can generate a corresponding token according to the credential information stored in the card shaped mobile payment device to perform payment operation. Further, the card shaped mobile payment device can perform the payment operation in an offline manner, and does not need to directly or indirectly communicate with the token service provider to transmit payment information, so as to achieve the safety and convenience of the offline operation. In addition, the card shaped mobile payment device complies with the authentication procedures and secure transaction mechanisms required by the International Credit Card Organization, and ensures transaction security, reduces the possibility of fraud, and increases the security of the mobile payment device in payment without changing the way of using credit cards.

What is claimed is:

1. An operation method of a card shaped mobile payment device, in which the card shaped mobile payment device includes a security chip, an antenna unit electrically connected to the security chip, a central control unit electrically connected to the security chip, the operation method comprising:
executing an identity authentication operation, wherein the central control unit determines whether the identity authentication operation is successful according to a dual authentication result, and the dual authentication result includes a fingerprint authentication result and a PIN code authentication result of the security chip; and
executing an offline payment operation, which includes:
confirming a card information, wherein the central control unit transmits a card index information of a selected card information to the security chip;
activating a payment process, wherein the security chip generates a token information, which is time-sensitive, based on the card credential information corresponding to the card index information; and
executing a transaction operation, such that the antenna unit establishes a communication connection with a transaction device, so as to provide the token information to the transaction device to execute a transaction.

2. The operation method of a card shaped mobile payment device according to claim 1, wherein the identity authentication operation includes:
executing a fingerprint authentication operation, wherein a fingerprint sensing module senses and generates the fingerprint authentication result, such that the central control unit receives the fingerprint authentication result and accordingly determines whether the fingerprint authentication operation is successful; and
executing a PIN code authentication operation for transmitting a pre-stored PIN code to the security chip, wherein the security chip compares the pre-stored PIN code with the authentication PIN code stored in the security chip to generate a corresponding PIN code authentication result, and the central control unit receives the PIN code authentication result, and accordingly determines whether the PIN code authentication operation is successful,
wherein the central control unit determines whether the identity authentication operation result is successful based on the fingerprint authentication result and the PIN code authentication result.

3. The operation method of a card shaped mobile payment device according to claim 2, wherein when a number of failed fingerprint authentication operations exceeds a first threshold value and a number of failed user PIN code authentication operations exceeds a second threshold value, the card shaped mobile payment device executes a lock mode to disable the card shaped mobile payment device.

4. The operation method of a card shaped mobile payment device according to claim 3, wherein the user PIN code authentication enables the central control unit to compare a received user PIN code with the pre-stored PIN code to obtain a comparison result, and determine whether the user PIN code authentication operation succeeds or fails according to the comparison result.

5. The operation method of a card shaped mobile payment device according to claim 3, further including:
executing an unlock operation, wherein the card shaped mobile payment device communicates with an electronic device, an identity authentication device of the electronic device performs an authentication operation with, and after completing the authentication operation, the lock mode is released.

6. The operation method of a card shaped mobile payment device according to claim 1, wherein when the central control unit determines that a display time of a display screen of the display module exceeds a preset value, and does not receive an input signal from an input interface of the card shaped mobile payment device, a card information displayed by the display screen is used as the selected card information.

7. The operation method of a card shaped mobile payment device according to claim 5, further including:
determining an execution mode, wherein when the card shaped mobile payment device is in a non-charging status, the offline payment operation in an offline payment mode is executed.

8. The operation method of a card shaped mobile payment device according to claim 5, further including:
determining an execution mode, wherein when the card shaped mobile payment device is in a charging status, the card shaped mobile payment device executes a connection control mode and communicates with an electronic device, and a user interface of the electronic device replaces the input interface to remotely control the card shaped mobile payment device.

9. The operation method of a card shaped mobile payment device according to claim 1, wherein the central control unit enables the display module to display two consecutively displayed display images in different directions.

10. The operation method of a card shaped mobile payment device according to claim 1, wherein the central control unit enables an NFC wireless controller of the security chip to activate the antenna unit, so as to establish a communication connection between the antenna unit and the transaction device.
